(19) United States
(12) Patent Application Publication
(10) Pub. No.: US 2005/0029285 A1
(43) Pub. Date: Feb. 10, 2005

(54) Containers and methods for the on-demand dispensing of flowable materials

(75) Inventors: Randolph G. Gay III, Chesapeake, VA (US); Adam P. Burke, Williamsburg, VA (US)

Correspondence Address: NIXON & VANDERHYE, PC, 1100 N GLEBE ROAD, 8TH FLOOR, ARLINGTON, VA, 22201-4714, US

(73) Assignee: PBM Plastics, Inc., Newport News, VA (US)

(21) Appl. No.: 10/805,492

(22) Filed: Mar. 22, 2004

Related U.S. Application Data
(60) Provisional application No. 60/456,566, filed on Mar. 24, 2003.

(51) Int. Cl. G01F 11/00

(52) U.S. Cl. 222/1; 222/105

(57) ABSTRACT

Containers and methods are disclosed whereby portions of an available stand-by supply of flowable material within a container may be dispensed substantially immediately on-demand. Preferably, the containers include an open-ended container shell having a resilient, shape-retaining side wall defining an interior space, a liner positioned within the interior space of the container shell, and a cap closing the open-ended container shell to seal the liner against leakage of flowable material. The liner has a flaccid liner body for containing a flowable material to be dispensed. The cap has a discharge opening to allow an amount of flowable material to be discharged therethrough from the liner body. Importantly, the container includes a valve system which includes one-way discharge and inlet valves. The one-way discharge valve allows only flowable material to be discharged from the liner via the discharge opening, but prevents ambient air from being introduced into the liner when the discharge of flowable material is finished. The one-way inlet valve serves to trap air within the interior space of the container shell in response to a collapsing force applied against the side wall of the container shell which, in turn, allows ambient air to enter the interior space when such collapsing force is removed.

### FIELD OF THE INVENTION

The present invention relates generally to the field of containers employed to dispense flowable materials. In particularly preferred forms, the invention is embodied dispensing containers which allow on-demand dispensing of flowable materials contained therewithin and thereby ensure that substantially all such flowable materials are available and capable of being used.

### BACKGROUND AND SUMMARY OF THE INVENTION

A variety of flowable materials (e.g., liquids, gases. gels, powders, slurries and the like) are sometimes desired to be dispensed in portions from containers for their intended use. For example, certain food condiments (e.g., mustard, ketchup, mayonnaise and the like) are typically contained in a so-called squeeze bottle which enables them to be applied onto food in desired amounts through an outlet opening. When squeezed, therefore, the condiment will be forcibly urged through the outlet opening and onto the food.

Dispensing problems exist for any flowable material, however, when it only partially fills the interior volume of the container (i.e., which occurs after some of the contents in the container have been dispensed through periodic use). Thus, as the amount of flowable material within the container decreases, there is a corresponding increase in air volume within the container. This in turn means that the user will need to invert the container and shake it vigorously so that the flowable material remaining within the container is encouraged to migrate toward the outlet.

It would therefore be highly desirable if containers and methods could be provided which allow for the on-demand dispensing of flowable materials. Such on-demand dispensing capabilities would ensure that a quantity of a flowable material within the container may be substantially immediately discharged from the container regardless of the total amount of material that may be available as a stand-by supply therewithin. It is towards fulfilling such needs that the present invention is directed.

Broadly, the present invention is embodied in containers and methods whereby portions of an available stand-by supply of flowable material within a container may be dispensed substantially immediately on-demand. In especially preferred forms, the present invention is embodied in containers for dispensing flowable material having an open-ended container shell having a resilient, shape-retaining side wall defining an interior space, a liner positioned within the interior space of the container shell, and a cap closing the open-ended container shell to seal the liner against leakage of flowable material. The liner has a flaccid liner body for containing a flowable material to be dispensed. The cap has a discharge opening to allow an amount of flowable material to be discharged therethrough from the liner body.

Importantly, the container includes a valve system which provides for substantially simultaneous on-demand dispensing of flowable material from the liner through the discharge opening of the cap. The preferred valve system includes one-way discharge and inlet valves. The one-way discharge valves allows only flowable material to be discharged from the liner via the discharge opening, but prevents ambient air from being introduced into the liner when the discharge of flowable material is finished. On the other hand, the one-way inlet valve serves to trap air within the interior space of the container shell to permit the flowable material within the liner to be discharged through the discharge opening in response to a collapsing force applied against the side wall of the container shell. This in turn allows the ingress of ambient air into the interior space when such collapsing force is removed to allow the side wall of the container shell to regain its original shape.

These and other aspects and advantages will become more apparent after careful consideration is given to the following detailed description of the preferred exemplary embodiments thereof.

### BRIEF DESCRIPTION OF THE ACCOMPANYING DRAWINGS

Reference will hereinafter be made to the accompanying drawings. wherein like reference numerals throughout the various FIGURES denote like structural elements, and wherein:

FIG. 1 is an exploded perspective view of a particularly preferred embodiment of a dispensing container in accordance with the present invention;

FIG. 2 is a cross-sectional perspective view of the dispensing container depicted in FIG. 1 but shown in an assembled state; and

FIGS. 3-7 are cross-sectional elevational views of the dispensing container in accordance with the present invention showing schematically a series of its operational cycles.

### DETAILED DESCRIPTION OF THE INVENTION

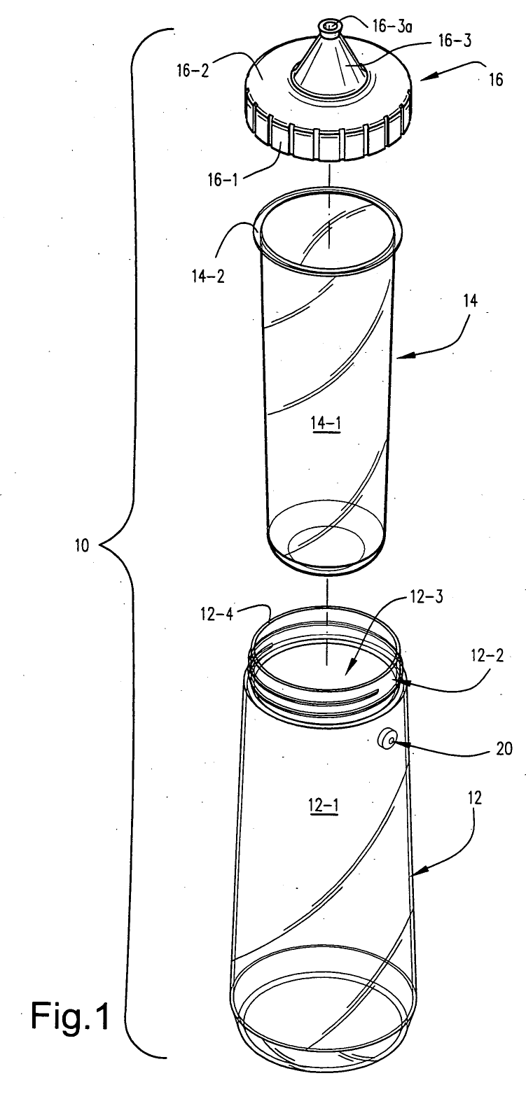

As shown in accompanying FIG. 1, a particularly preferred embodiment of the present invention includes an open-ended, shape-retaining flexible outer container shell 12, a liner 14 and a dispensing cap 16. The liner 14 unitarily includes a flaccid elongate body portion 14-1 having a closed bottom, and an open-ended top defined by a self-supporting and shape-retaining annular flange member 14-2. Most preferably, the flexible liner 14 is one that is described more fully in U.S. Pat. Nos. 4,836,764 and 5,091,231, the entire content of each being incorporated hereinto by reference.

By the term “self-supporting” is meant that the structure is capable of supporting its own weight against gravity without deformation. Thus, the flaccid body portion 14-1 is non-self-supporting since it is incapable of supporting its own weight against gravity. The term “shape retaining” means that the structure is capable of retaining and/or resiliently returning to its original shape after the application of a deformation force. Thus. the flange member 14-2 of the liner is yieldable to a deformation force, but is sufficiently pliant and resilient to return substantially to its originally annular shape after the deformation force is released. Similarly, the side wall 12-1 of the container shell 12 is self-supporting and shape-retaining. As such, it provides structural support to itself and to the other components of the container 10 (including supporting the quantity of flowable material within the liner 14), while yet being capable of yielding to a deformation force (e.g., due to a user squeezing its side wall 12-1). On release of such deformation force the container shell 12 will resiliently return to its original shape.

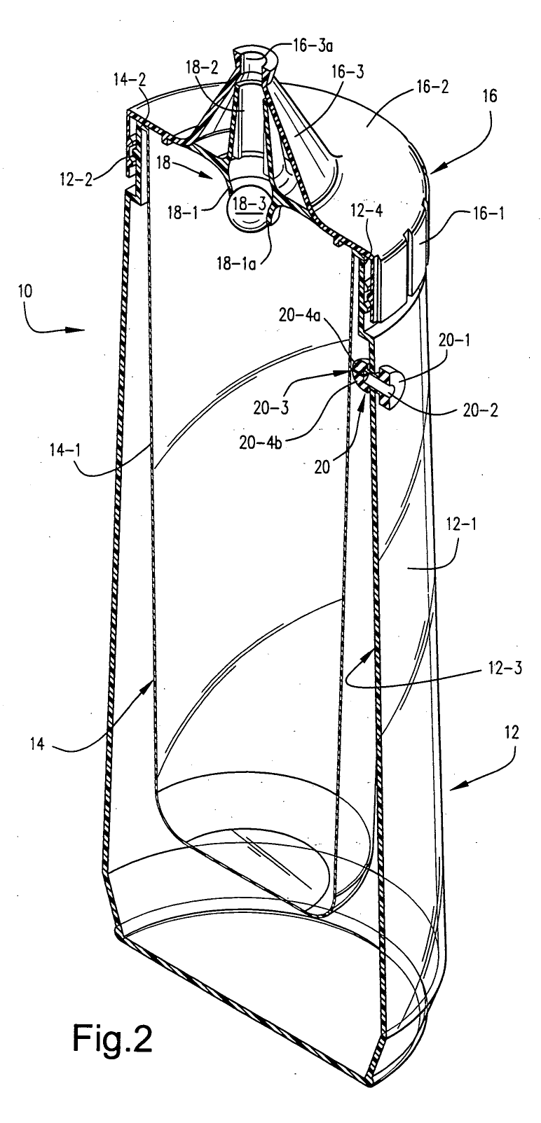

The generally cylindrically-shaped side wall 12-1 of the container shell 12 includes an upper threaded region 12-2 which threadably mates with the cylindrical flange 16-1 of the cap. As depicted perhaps more clearly in accompanying FIG. 2, the flaccid body portion 14-1 of the liner 14 is received within the interior space 12-3 of the container shell 12. The liner 14 is supported dependently within the interior space 12-3 of the container shell 12 by means of its annular flange member 14-2 being seated on the shell's upper conformingly shaped annular edge 124. Thus, when the cap 16 is threadably mated to the threaded upper open end 12-2 of the container shell 12, the flange member 14-2 of the liner 14 will be captured between the closure disc 16-2 of the cap 16 and the upper edge 12-4 of the container shell 12 thereby forming a fluid-tight seal. As such, leakage of the flowable material from the liner 14 is prevented.

Important to the present invention, the cap 16 includes a one-way discharge valve 18 and the container shell includes a one-way inlet valve 20. In this regard, the discharge valve 18 is provided in operative association to communicate with the discharge nozzle 16-3 of the cap 16, while the inlet valve 20 is provided in operative association to communicate with the interior space 12-3 of the container shell 12.

The particular structural aspects of the one-way discharge and inlet valves 18, 20, respectively, depicted in the accompanying FIGURES are not critical to the present invention and may in fact vary depending on a number of factors including the specific shape and/or configuration of the container 10, the amount and/or type of flowable material contained within the liner 14, and the like. Regardless of the structures employed, however, it is important that the discharge valve 18 allows only the flowable material to be discharged from the liner 14 via the discharge nozzle 16-3 (i.e., through the discharge opening 16-3a at its terminal end) and does not allow ambient air to be introduced into the liner 14 when the discharge of flowable material is finished. Similarly, it is important for the inlet valve 20 to be capable of trapping air within the interior space 12-3 to permit the flowable material to be discharged in response to a collapsing (squeezing) force applied against the side wall 12-1 of the container shell 12, but yet allows the ingress of ambient air into the interior space 12-3 when such collapsing (squeezing) force is removed to allow the resilient side wall 12-1 of the container shell 12 to regain its original shape.

In the presently preferred embodiment, the one-way discharge valve 18 includes an annular valve seat 18-1 defining a discharge port 18-1a, a discharge conduit 18-2 connected to the valve seat 18-1 and opening into the discharge nozzle 16-3, and a ball plug 18-3 operatively associated with the valve seat 18-1. The ball plug 18-3 is thus moveable relative to the valve seat 18-1 between an unseated and seated conditions so as to open and close the discharge port 18-1a, respectively. In the unseated condition, the flowable material within the liner body 14-1 is permitted to flow through the discharge port 18-1a of the valve seat 18-1, the discharge conduit 18-2 and the discharge opening 16-3a of the discharge nozzle 16-3 in that order. Conversely, in the seated condition, the ball plug 18-3 is sealingly seated in the valve seat 18-1 and thereby sealably closing the discharge port 18-1a which, in turn, prevents ambient air (as well as any residual amounts of flowable material remaining in the discharge conduit 16-3 and nozzle 18-2) from entering the liner body 14-1.

The one-way inlet valve 20 in the presently preferred embodiment of the container 10 according to this invention, is a one-piece resilient valve structure having at one end an inlet flange 20-1 defining an inlet opening 20-2, and having at its other end a split tip 20-3 defining a pair of sealing flaps 20-4a, 20-4b. The sealing flaps 20-4a, 20-4b are thus capable of being resiliently urged apart slightly from their normally sealed contact with one another sufficiently to allow fluid communication to be established between the opening 20-2 of the inlet valve 20 and the interior space 12-3 of the container shell 12.

When the side wall 12-1 is subjected to a radially compressive force tending to collapse it, air is trapped within the interior space due to the sealing flaps 20-4a. 20-4b being in sealed contact with one another. As such, the trapped air prevented from escaping the interior space 12-3 thereby causing the compressive force to be transferred, via such trapped air, to the flaccid liner body 14-1. Since the ball plug 18-3 will thereby be responsively moved to an unseated condition, the flowable material is caused to be discharged through the discharge nozzle 16-3 as described previously. When the compressive force is removed from the side wall 12-1, its inherent resiliency will encourage it to regain its original (uncompressed) condition. As such, the ball plug 18-3 will responsively be moved to its seated condition thereby sealing the discharge conduit 18-2 to prevent ambient air from entering therethrough and into the line 14. At the same time, the resilient expansion of the side wall 12-1 will cause the sealing flaps 20-4a, 20-4b of the inlet valve 20 to separate so that ambient air is allowed to enter the interior space 12-3 through the valve opening 20-2. The flaccid liner body 14-1 will thus maintain its collapsed state in an amount commensurate with the volume of flowable material that has been discharged therefrom.

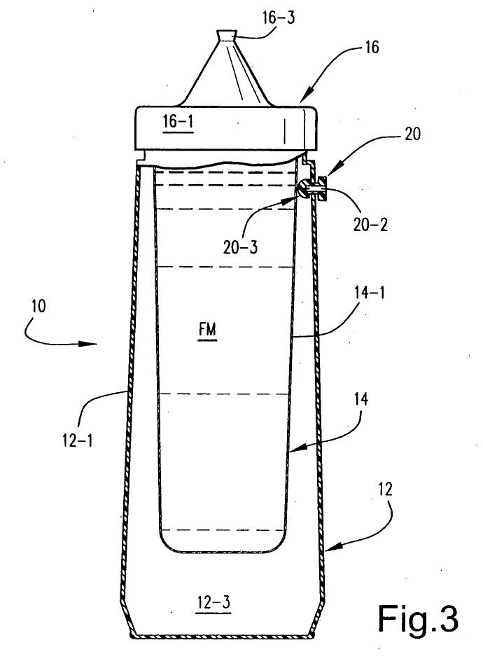

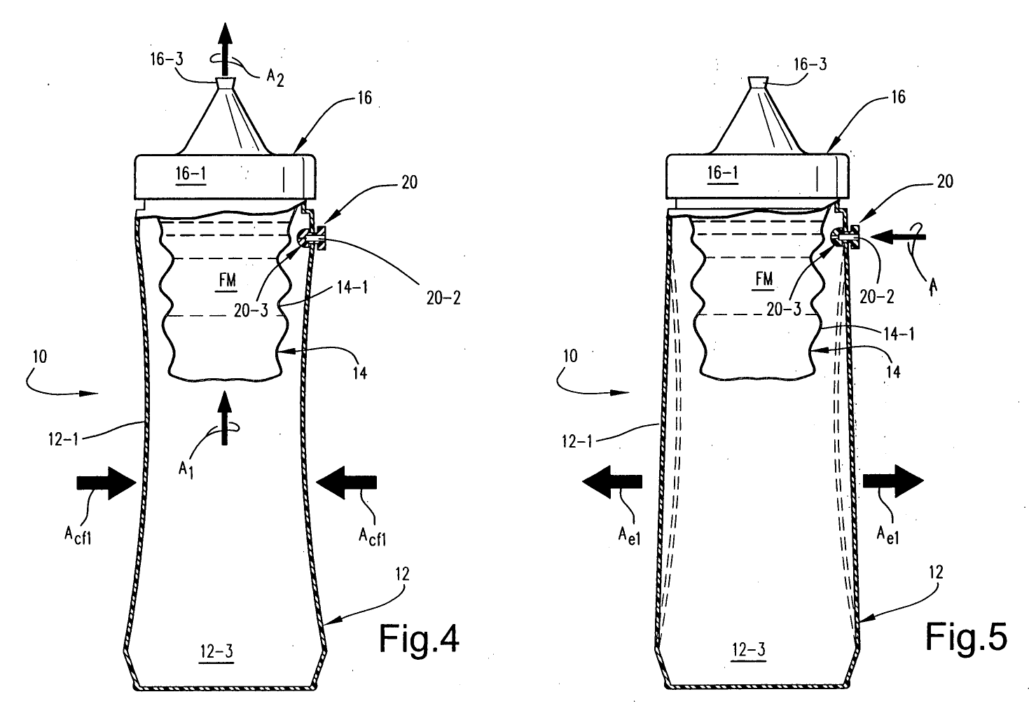

The functioning of the container 10 in accordance with the present invention as described above is depicted schematically in accompanying FIGS. 3-7. In this regard, FIG. 3 depicts the rest state of a container 10 in accordance with the present invention in which the liner body 14-1 is filled with a flowable material FM. As depicted in FIG. 4, upon application of a radially compressive force (arrows A_{cf1}) applied to the side wall 12-1 of the container shell 12, the trapped air within the interior space 12-3 and sealed by valve 20 will force (arrow A₁) the flaccid liner body 14-1 to collapse on itself thereby causing a portion of the flowable material FM to be discharged (arrow A₂) through the nozzle 16-3.

When the compressive force is removed, the inherent resiliency of the side wall 12-1 will cause it to expand (arrows Aₑ₁) from its collapsed shape (shown by dashed lines in FIG. 5) to its original shape (shown in solid lines in FIG. 5). Simultaneously with such side wall expansion, ambient air is allowed to enter the interior space 12-3 of the container shell 12 via the inlet opening 20-2 of valve 20 by virtue of the split tip 20-3 thereof being unsealed. As noted previously, at this time the ball plug 18-3 has assumed its seated (sealed) condition with respect to the valve seat 18-1 thereby preventing ambient air from entering into the liner body 14-1 through the nozzle 16-3. In such a manner, therefore, the flaccid liner body 14-1 will remain collapsed partially on itself once the side wall 12-1 regains its original shape.

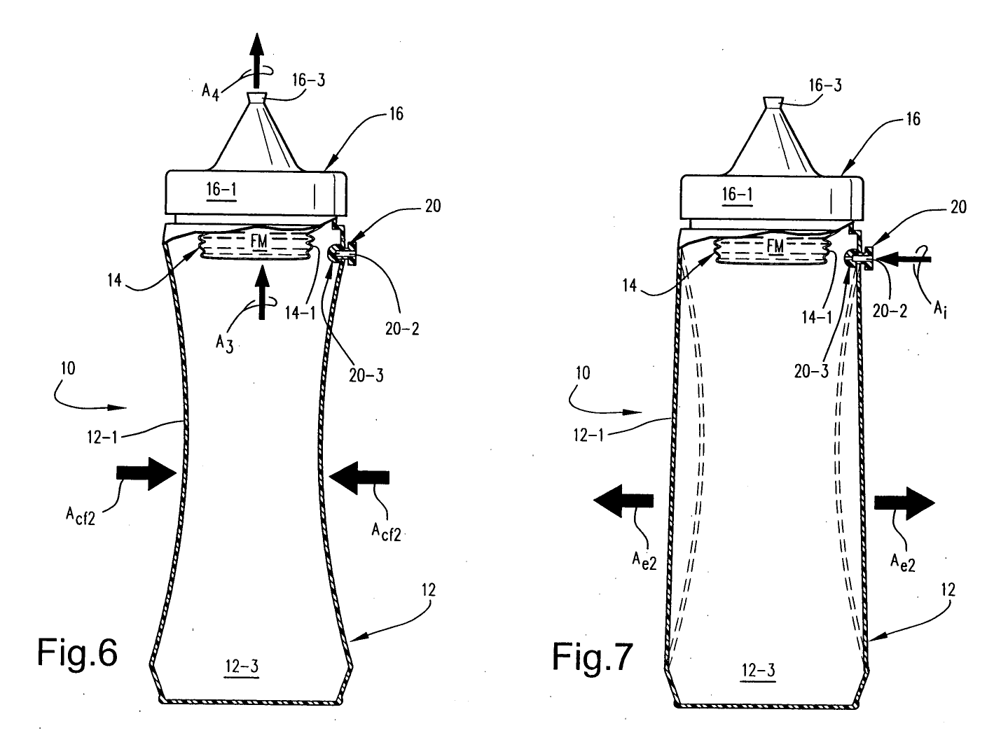

As depicted in FIGS. 6 and 7, if yet another radially compressive force (arrow A_{cf2}) is applied to the side wall 12-1 of the container shell 12, the trapped air within the interior space 12-3 will again force (arrow A₃) the flaccid liner body 14-1 to collapse further onto itself thereby causing another portion of the flowable material FM to be discharged (arrow A₄) through the nozzle 16-3. Thereafter, release of the compressive force will again allow the inherent resiliency of the side wall 12-1 to expand it (arrows Aₑ₂) from its collapsed shape (shown by dashed lines in FIG. 7) to its original shape (shown in solid lines in FIG. 7). This in turn simultaneously again allows ambient air to enter the interior space 12-3 of the container shell 12 via the inlet opening 20-2 of valve 20 by virtue of the split tip 20-3 thereof being unsealed. As in the prior discharge cycle, the ball plug 18-3 has assumed its seated (sealed) condition with respect to the valve seat 18-1 thereby preventing ambient air from entering into the liner body 14-1 through the nozzle 16-3. In such a manner, therefore, the further collapsed condition of the flaccid liner body 14-1 will be retained while the side wall 12-1 regains its original shape.

The number of side wall compression/expansion cycles as described above is of course limited by the volume of flowable material within the liner body 14-1 and the amount of the same that is discharged therefrom during each cycle. Thus, although the accompanying FIGS. 3-7 depict only two such cycles, it should be understood that such FIGURES have been presented in a schematic manner for the purpose of description clarity. Hence, in practice it is envisioned that numerous discharge cycles will be performed since relatively small amounts of flowable material will be discharged during each such cycle.

It should now be readily apparent that the container 10 in accordance with the present invention allows the flowable material FM contained within the body liner 14 to be discharged essentially “on demand”. As used herein and in the accompanying claims, the term “on demand” means that no air space or gap exists between the level of flowable material contained within the liner 14 and the discharge port 18-1a of the valve seat 18-1 so that the flowable material is essentially immediately available for discharge through the discharge port 18-1a in response to a compressive force being applied to the resilient side wall 12-1 of the container shell 12.

One particularly beneficial attribute of the “on demand” characteristic of the present invention, therefore, is that the container 10 does not necessarily need to be inverted in order to allow flowable material to be discharged therefrom. In fact, the container 10 may be operated so as to discharge flowable material FM while in an upright condition.

Several other advantages may ensue from the present invention. For example, since the flowable material is contained within a relatively thin-walled flaccid liner 14, it is conceivable that consumers would only need a one-time investment for the container shell 12. Liners 14 filled with flowable material could then be offered separately to the consumer as “refills”. In such a manner, considerable packaging costs could be avoided with such savings being passed on to the ultimate consumers.

In addition, virtually all of the flowable material within the liner 14 is available for use since it is physically assisted to be moved toward the discharge nozzle 16-3. As such, minimal material waste may be enjoyed by using the present invention. At the same time, the aggravating conventional practice of having to shake an inverted container is virtually eliminated.

Therefore, while the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A container for dispensing flowable material comprising:
an open-ended container shell having a resilient, shape-retaining side wall defining an interior space;
a liner positioned within the interior space of the container shell, and having a flaccid liner body for containing a flowable material to be dispensed; and
a cap closing the open-ended container shell and sealing the liner against leakage of flowable material, said cap having a discharge opening to allow an amount of flowable material to be discharged therethrough from the liner body, wherein
said container includes a valve system which provides for substantially simultaneous on-demand dispensing of flowable material from the liner through the discharge opening of the cap.

2. The container of claim 1, wherein said valve system includes a one-way discharge valve which allows only flowable material to be discharged from the liner via the discharge opening, but prevents ambient air from being introduced into the liner when the discharge of flowable material is finished.

3. The container of claim 2, wherein said discharge valve includes an annular valve seat, and a ball plug operatively associated with said valve seat and moveable between an unseated condition therewith to allow discharge of flowable material from the liner, and a seated condition therewith to prevent ambient air from entering the liner.

4. The container of claim 1, 2 or 3, wherein the valve system includes a one-way inlet valve for trapping air within the interior space of the container shell to permit the flowable material within the liner to be discharged through the discharge opening in response to a collapsing force applied against the side wall of the container shell, and allows the ingress of ambient air into the interior space when said collapsing force is removed to allow the side wall of the container shell to regain its original shape.

5. The container of claim 4, wherein the inlet valve includes one-piece resilient valve structure having at one end an inlet flange defining an inlet opening, and having at its other end a split tip.

6. The container of claim 5, wherein the split tip establishes a pair of sealing flaps capable of being resiliently urged apart slightly from their normally sealed contact with one another sufficiently to allow fluid communication to be established between the opening of the inlet valve and the interior space of the container shell.

7. The container of claim 1, wherein said liner unitarily includes said flaccid body portion, and an upper annular self-supporting flange.

8. The container of claim 1, wherein said container shell and said cap are threadably coupled one to another.

9. A method for dispensing a flowable material from a container of claim 1, comprising the steps of:
(a) applying a compressive force to the side wall of the container shell to responsively cause a selected amount of flowable material contained within the liner to be discharged through the discharge opening via the one-way discharge valve;
(b) releasing the applied compressive force and allowing the side wall to resiliently expand to its original uncompressed condition; while substantially simultaneously;
(c) allowing the one-way discharge valve to close and the one-way inlet valve to open to thereby prevent ambient air from entering the liner but permit ambient air to enter the interior space of the container shell as it expands to its original uncompressed condition.

10. The method of claim 9, comprising repeating steps (a)-(c) to cause another selected amount of flowable material to be discharged through the discharge opening.

11. The method of claim 9 or 10, wherein said flowable material is selected from liquids, gases, gels, powders, slurries.

12. The method of claim 11, wherein said flowable material is a flowable food condiment selected from mustard, ketchup and mayonnaise.

13. A dispensing container comprising:
an open-ended container shell having a resilient, shape-retaining side wall defining an interior space;
a liner positioned within the interior space of the container shell, and having a flaccid liner body;
a volume of flowable material contained within the flaccid liner body; and
a cap closing the open-ended container shell and sealing the liner against leakage of the flowable material, said cap having a discharge opening to allow an amount of the flowable material to be discharged therethrough from the liner body, wherein
said container includes a valve system which provides for substantially simultaneous on-demand dispensing of the flowable material from the liner through the discharge opening of the cap.

14. The container of claim 13, wherein said valve system includes a one-way discharge valve which allows only flowable material to be discharged from the liner via the discharge opening, but prevents ambient air from being introduced into the liner when the discharge of flowable material is finished.

15. The container of claim 14, wherein said discharge valve includes an annular valve seat, and a ball plug operatively associated with said valve seat and moveable between an unseated condition therewith to allow discharge of flowable material from the liner, and a seated condition therewith to prevent ambient air from entering the liner.

16. The container of claim 13, 14 or 15, wherein the valve system includes a one-way inlet valve for trapping air within the interior space of the container shell to permit the flowable material within the liner to be discharged through the discharge opening in response to a collapsing force applied against the side wall of the container shell, and allows the ingress of ambient air into the interior space when said collapsing force is removed to allow the side wall of the container shell to regain its original shape.

17. The container of claim 16, wherein the inlet valve includes one-piece resilient valve structure having at one end an inlet flange defining an inlet opening, and having at its other end a split tip.

18. The container of claim 17, wherein the split tip establishes a pair of sealing flaps capable of being resiliently urged apart slightly from their normally sealed contact with one another sufficiently to allow fluid communication to be established between the opening of the inlet valve and the interior space of the container shell.

19. The container of claim 13, wherein said liner unitarily includes said flaccid body portion, and an upper annular self-supporting flange.

20. The container of claim 13, wherein said container shell and said cap are threadably coupled one to another.

21. The container of claim 13, wherein said flowable material is selected from liquids, gases, gels, powders, slurries.

22. The container of claim 13, wherein said flowable material is a flowable food condiment selected from mustard, ketchup and mayonnaise.
